(19) United States
(12) Patent Application Publication
(10) Pub. No.: US 2026/0090509 A1
(43) Pub. Date: Apr. 2, 2026

(54) Crop Management System Based on a Language Model with State Reconstruction and Reinforcement Learning

(71) Applicant: The Board of Trustees of the University of Illinois, Urbana, IL (US)

(72) Inventors: Naira Hovakimyan, Champaign, IL (US); Jing Wu, Herndon, VA (US); Ran Tao, Savoy, IL (US); Yikun Cheng, Champaign, IL (US); Chuyuan Tao, Urbana, IL (US)

(21) Appl. No.: 19/331,239

(22) Filed: Sep. 17, 2025

Related U.S. Application Data
(60) Provisional application No. 63/701,922, filed on Oct. 1, 2024.
(60) Provisional application No. 63/721,833, filed on Nov. 18, 2024.

(51) Int. Cl. A01G 25/16; G05B 13/02

(52) U.S. Cl. CPC A01G 25/167; G05B 13/027

(57) ABSTRACT

Examples may involve obtaining a partial state of an agricultural environment, wherein the partial state includes representations of a weather status and a crop status, wherein a portion of the partial state is missing; providing, to a trained language model based reinforcement learning (LM-RL) agent, the partial state of the agricultural environment, wherein the trained LM-RL agent has been trained to, based on the partial state, predict an action that, when taken, causes an output of a utility function to be increased, wherein the action involves application of an amount of water and an amount of fertilizer to the agricultural environment, and wherein the utility function takes the partial state, the amount of the water and the amount of fertilizer as input and provides a future crop yield as the output; and providing, for display or storage, a representation of the action.

### CROSS-REFERENCE TO RELATED APPLICATIONS

This application claims priority to U.S. provisional patent application No. 63/701,922, filed Oct. 1, 2024, and to U.S. provisional patent application No. 63/721,833, filed Nov. 18, 2024, which are hereby incorporated by reference in their entirety.

### BACKGROUND

Food security is a primary goal in contemporary agriculture, highlighting the significance of management practices such as nitrogen fertilization and water irrigation. These techniques are used not only for increasing crop yields and providing a stable food supply but also play a role in sustaining environmental health. Traditional best practices in these domains, informed by empirical experience, are now being tested against the backdrop of changing climatic conditions. This raises concerns about their continued effectiveness, underscoring the need for more innovative, efficient, and adaptable agricultural management systems.

Conventional fertilization and water irrigation practices, though long relied upon to boost crop yields, often result in inefficiencies such as nutrient leaching, water waste, and elevated greenhouse gas emissions, particularly under shifting climates. These inefficiencies not only waste fertilizer and water, but also exacerbate environmental degradation, including soil depletion and contamination of groundwater. Existing agricultural management systems, largely based on generalized best practices, lack the adaptability to respond dynamically to variable weather patterns, soil conditions, and crop demands. This creates a pressing technical problem: how to design sustainable, resource-efficient approaches to fertilizer and water use that can improve productivity, reduce waste, and mitigate environmental impacts.

### SUMMARY

Various implementations disclosed herein include using a language model (LM) as a reinforcement learning (RL) agent to improve crop management practices. The application of this advanced artificial intelligence (AI) enhances agricultural practices by addressing significant challenges thereof in the pursuit of more sustainable and productive farming methodologies. A distinguishing feature of the embodiments herein is that the states used for decision-making are partially observed through random masking. Consequently, an RL agent is tasked with two primary objectives: improving management policies and inferring masked states. This approach significantly enhances the RL agent's robustness and adaptability across various real-world agricultural scenarios.

Extensive experiments on maize crops in Florida, USA, and Zaragoza, Spain, validate the effectiveness of these techniques. Not only did they achieve State-of-the-Art (SoTA) results across various evaluation metrics such as production and sustainability, but the trained management policies are also immediately deployable in over ten of millions of real-world contexts. Furthermore, the pre-trained policies possess a noise resilience property, which enables them to reduce potential sensor biases, thereby increasing robustness and generalizability. Additionally, unlike previous methods, a strength of the embodiments herein lies in their computationally efficient structure, which eliminates the need for pre-defined states or multi-stage training.

Accordingly, the present disclosure provides technical improvements that extend beyond computational performance to encompass advancements in environmental and resource conservation. Utilization of a language model-based reinforcement learning agent as described herein reduces reliance on redundant data collection and reduces computational overhead while simultaneously improving the precision of water and fertilizer application. As a consequence, these embodiments achieve reductions in resource waste, nutrient leaching, and greenhouse gas emissions associated with excessive nitrogen application. Unlike conventional approaches, the disclosed systems and methods exhibit robustness and adaptability across diverse agricultural environments, thereby facilitating scalable deployment. Accordingly, the disclosed embodiments not only improve the robustness, adaptability, and generalizability of computer-implemented crop management systems, but further provide improvements in sustainability by conserving water resources, maintaining soil quality, and mitigating environmental pollution.

A system of one or more computers can be configured to perform particular operations by virtue of having software, firmware, hardware, or a combination thereof installed on the system that in operation causes or cause the system to perform the operations. One or more computer programs can be configured to perform particular operations by virtue of including instructions that, when executed by data processing apparatus, cause the apparatus to perform the operations.

One general aspect includes a computer-implemented method that involves obtaining a partial state of an agricultural environment, where the partial state includes representations of a weather status and a crop status, where a portion of the partial state is missing. The method also includes providing, to a trained language model based reinforcement learning (LM-RL) agent, the partial state of the agricultural environment, where the trained LM-RL agent has been trained to, based on the partial state, predict an action that, when taken, causes an output of a utility function to be increased, where the action involves application of an amount of water and an amount of fertilizer to the agricultural environment, and where the utility function takes the partial state, the amount of the water and the amount of fertilizer as input and provides a future crop yield as the output. The method also includes providing, for display or storage, a representation of the action. Other embodiments of this aspect include corresponding computer systems, apparatuses, and computer programs recorded on one or more computer storage devices, each configured to perform the methods.

Another general aspect includes a computer-implemented method that involves obtaining a complete state of an agricultural environment, where the complete state includes representations of weather status and crop status. The method also includes training an LM-RL agent to predict actions to take on the agricultural environment by performing, until a stopping criterion is satisfied, steps including: masking a subset of the complete state to form a partial state; applying the LM-RL agent to the partial state to predict: (i) a recovered complete state, and (ii) an action to take on the agricultural environment, where the action involves application of an amount of water and an amount of fertilizer to the agricultural environment, and where predicting the action involves evaluating a utility function that takes the partial state, the amount of the water, and the amount of fertilizer as input and provides a future crop yield as output; and applying a loss function to adjust parameters of the LM-RL agent, where the loss function is based on the future crop yield, the complete state, and the recovered complete state; and updating the complete state based on a simulated application the amount of the water and the amount of fertilizer to the agricultural environment. Other embodiments of this aspect include corresponding computer systems, apparatuses, and computer programs recorded on one or more computer storage devices, each configured to perform the methods.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a framework for language model based reinforcement learning with masking, in accordance with example embodiments.

FIG. 4 depicts a comparison of agent-based learning techniques, in accordance with example embodiments.

FIG. 5 depicts reward functions and weights, in accordance with example embodiments.

FIGS. 6A and 6B depict case study evaluation results, in accordance with example embodiments.

FIG. 7 depicts a performance comparison of a masking-based reinforcement learning agent with previous techniques, in accordance with example embodiments.

FIGS. 8A and 8B depict performance in the presence of ablation and masking, respectively, in accordance with example embodiments.

FIG. 9 depicts performance in the presence of measurement noise, in accordance with example embodiments.

FIG. 10 is a flow chart, in accordance with example embodiments.

FIG. 11 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of software features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

As used herein, terminology indicating extrema, such as “maximum,” “minimum,” “optimum,” and all linguistic variations thereof, should not be construed as indicating an absolute or exact state but rather as a general indication of progression toward that goal. These terms are intended to describe a direction or trend toward improvement, enhancement, or optimization, without implying that the described elements or steps must reach or achieve an ultimate or best possible outcome. The use of such terms should be interpreted as encompassing implementations that improve or enhance a function or result, even if they do not reach the theoretical or absolute ideal. Thus, this language of extrema is intended to include various embodiments that are close to, but may not necessarily achieve, a literal maximum, minimum, optimum, or similar condition.

### I. EXAMPLE COMPUTING DEVICES AND CLOUD-BASED COMPUTING ENVIRONMENTS

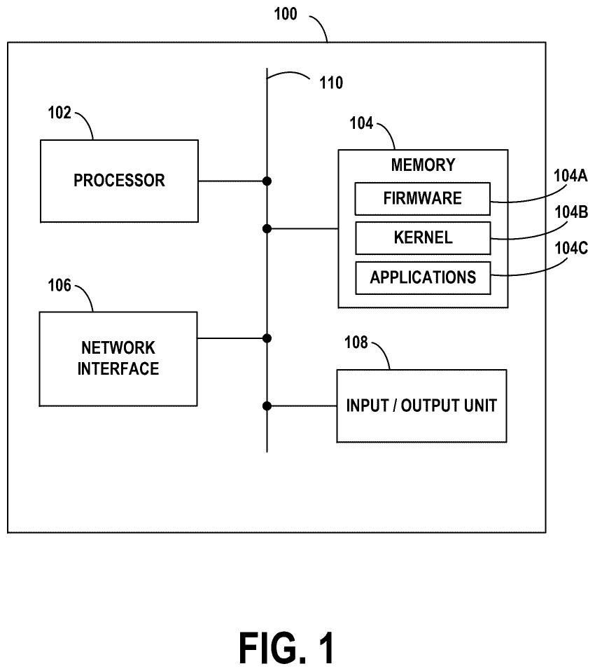

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), a digital signal processor (DSP), a network processor, an encryption processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently used instructions and data.

GPUs, in particular, have grown in importance. They include specialized circuitry designed to perform rapid mathematical calculations for rendering graphics, processing large datasets, and supporting machine learning. A GPU typically consists of hundreds or thousands of small cores that operate simultaneously, facilitating the decomposition of tasks into smaller, more manageable pieces that are processed in parallel. This parallelism allows GPUs to be significantly faster than traditional CPUs for certain types of calculations.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Herein, any non-volatile memory may be referred to as persistent storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Synchronous Digital Hierarchy (SDH), Data Over Cable Service Interface Specification (DOCSIS), or other technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

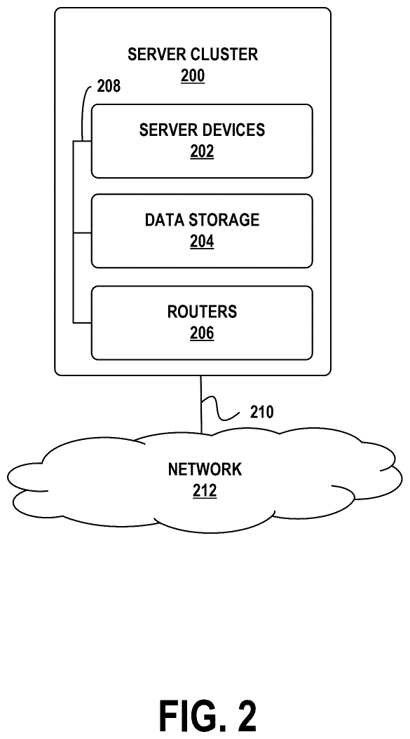

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### II. REINFORCEMENT LEARNING IN AGRICULTURAL TECHNOLOGY

Recent advancements in agricultural technology have introduced multi-layer perception (MLP)-based reinforcement learning (RL) agents (MLP-based agents) and language-model-based reinforcement learning agents (LM-based agents) for training nitrogen and irrigation management policies using a Decision Support System for Agrotechnology Transfer (DSSAT), notably the Gym-DSSAT simulator. These advances demonstrated the ability of such policies to surpass a baseline by producing higher yields or achieving similar yields with less nitrogen input under full observation conditions. However, the practical implementation of these policies in real-world scenarios is hindered by their reliance on comprehensive observational data, such as nitrate leaching and plant nitrogen uptake, which are typically not readily available to farmers. Thus, prior techniques are limited because they require data that may not be available in practice.

Attempts to bridge this gap include crop management frameworks that combine RL, imitation learning (IL), and crop simulations using DSSAT and Gym-DSSAT. Herein, these trained agents are referred to as the imitation-learning-based agent (IL-based agent). This approach enhances the adaptability and applicability of the management policies to real-world agricultural settings by addressing the challenge of partial observations.

While IL has proven effective in refining existing agricultural strategies by better aligning them with the practical realities of farming, there is significant variability in the availability of states in real-world scenarios. This variation is often case-specific, dictated by factors such as the deployment of sensors and the unique characteristics of different environments. Consequently, one state that is observable and accessible in one location may not be available in another, posing a notable challenge. This inconsistency in state availability can severely limit the applicability of imitation learning.

Additionally, the two-stage training approach used in RL and IL represents a significant limitation in the context of agricultural management optimization. Unlike an integrated, end-to-end framework, these methods typically involve using an expert policy, pretrained in a fully observed setting, to guide the RL agent in scenarios with only partial observations. Such a bifurcated training process can potentially lead to suboptimal distribution of resources like nitrogen and water. This is because the prior knowledge in expert policy, developed under the assumption of complete information, may not be transferred effectively to settings where only limited data is available. Consequently, this approach might result in management strategies that are both less efficient and less effective, wasting computational resources.

Addressing the aforementioned challenges, the embodiments herein provide a more robust and universally applicable RL agent trained within a unified framework. Utilization of LMs as enhanced RL agents can perform well across diverse scenarios. Although potent in their capabilities, these models are primarily configured for scenarios with full access to all states in simulations, limiting their direct deployability in real-world settings. Building on this limitation, the embodiments herein introduce the masking technique as an auxiliary component.

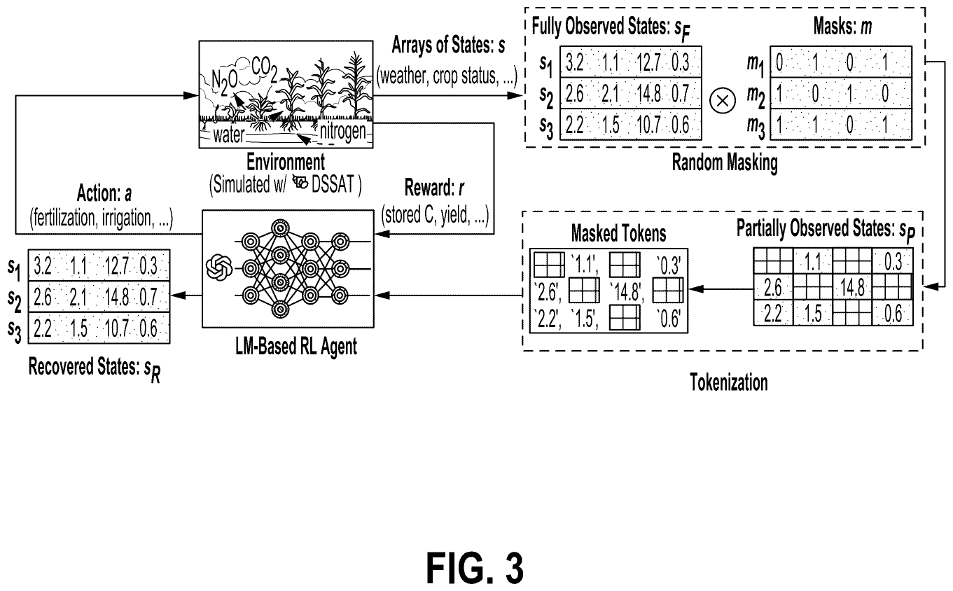

To be more specific, an intelligent crop management framework can incorporate a powerful LM-based RL agent, state masking strategy, and crop simulations via Gym-DSSAT. FIG. 3 illustrates the overall framework. Instead of an MLP-based RL agent, a more powerful LM-based agent is employed, exhibiting an improved ability to enhance crop yields and promote sustainability amidst the complexities of optimization tasks. A state masking strategy is used to replicate the inherent uncertainties of real-world agricultural scenarios. Consequently, the LM-based RL agent is charged with a twofold task: executing management decisions and reconstructing obscured states. This development not only enables the RL agent to make smarter decisions when information is incomplete but also strengthens its ability to make reliable and noise-agnostic decisions in the presence of the unpredictability that farmers often face. Furthering, the combining of these two tasks results in a smaller, more tractable model that can produce superior results on less data and with less computational complexity.

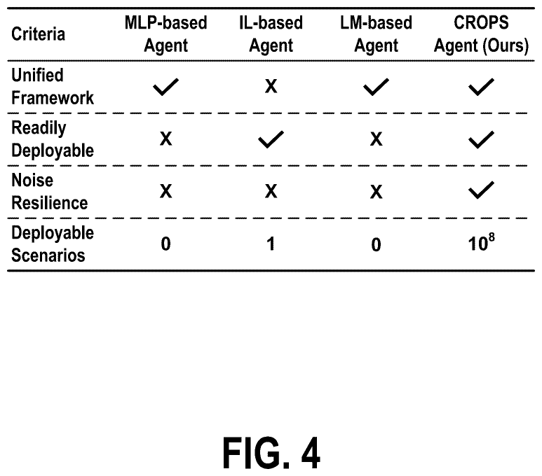

These features combine into a system with the following advantages: (i) LMs, utilizing random state masking and reconstruction, function as superior bi-task RL agents for crop management and missing state recovery, (ii) a unified framework that is readily deployable, noise-resilient, and applicable to ten millions of real-world contexts, and (iii) empirical demonstrations that the embodiments herein outperform existing SoTA approaches in extensive experiments, assessing metrics such as crop yield, resource utilization, environmental impact, and robustness in both fully observed and partially observed settings. Other advantages may be present or possible. A summarized comparison to previous techniques is provided in FIG. 4 (the embodiments herein are referred to as “CROPS”).

### III. EXAMPLE MACHINE LEARNING TECHNIQUES

The embodiments herein employ or relate to a number of machine learning techniques, such as RL, IL, LM, and so on. For purposes of context, each will be briefly explained below.

### A. Reinforcement Learning (RL)

RL is a type of machine learning where an agent learns to make decisions by interacting with its environment to achieve a specific goal. The agent takes actions based on its current state, receives feedback from the environment in the form of rewards or penalties, and adjusts its actions over time to maximize the total reward. Unlike supervised learning, where the correct output is provided for each input during training, RL relies on trial and error. The agent explores different strategies and refines its behavior as it gains more experience, with the goal of developing a policy that provides the best actions to take in various situations. Some elements of RL include the agent, environment, state, action, reward, and policy. This approach is used in areas such as robotics and autonomous systems, where learning from experience and adapting to changing conditions is advantageous.

### B. Imitation Learning (IL)

IL is a machine learning approach where an agent learns to perform tasks by observing and mimicking the behavior of an expert or demonstrator. Instead of learning through trial and error as in RL, the agent relies on examples provided by a skilled entity to develop its understanding of how to act in various situations. The agent imitates the expert's actions, assuming that the expert's behavior represents an optimal, near-optimal, or at least sufficient solution to the problem. IL is particularly useful when it is difficult or time-consuming for an agent to explore an environment autonomously, or when mistakes can be costly. This method is often applied in tasks such as self-driving vehicles, where human expertise can guide the agent's learning process. It can be combined with other learning methods to fine-tune performance after initial training.

### C. Language Model (LM) Learning

A language model-based learning agent is an artificial intelligence system that leverages natural language models, like Generative Pre-trained Transformer (GPT) or Bidirectional Encoder Representations from Transformers (BERT), to interact with and learn from its environment through text-based communication. These agents can understand, generate, and respond to human language, enabling them to perform tasks that require comprehension and reasoning. Instead of relying solely on structured data or predefined environments, they use LMs to interpret instructions, ask clarifying questions, and adapt their actions based on textual feedback or descriptions of tasks. The agent learns from language input, either through explicit instructions or examples, and can improve its performance by interpreting corrections or guidance provided in natural language. These agents can be used in virtual assistants, automated customer service, and AI-driven research tools, where understanding and generating human-like language are desirable.

### IV. EXAMPLE METHODOLOGY

This section formally describes the crop management framework with an LM-based RL agent and state masking strategy. The first sub-section outlines how the crop management process can be formulated as a Markov Decision Process (MDP). The second sub-section details the masking strategy employed within the crop management setting during both training and inference phases. Finally, the last sub-section presents the unified framework that integrates a masking strategy with LMs.

### A. Formulation

Nitrogen fertilization and irrigation management are formulated as a finite MDP. Specifically, t denotes a day. For each day, sₜ represents the state on that day. The state sₜ includes data pertaining to weather, plant growth, and soil conditions, including root depth and cumulative nitrate levels, as observed in the simulation for that day. Given the environmental state sₜ, RL agents are trained to select an action aₜ from the action space A. This selection is guided by a policy π(sₜ,θₜ), where θₜ represents the policy parameters on that particular day. Notably, a pre-trained LM is employed to represent the policy. For the action aₜ, it comprises two key decisions: the quantity of nitrogen fertilizer, denoted as Nₜ, and the amount of irrigation water, Wₜ, to be applied. The effectiveness of these decisions is quantified by the reward rₜ(sₜ,aₜ) calculated based on the outcomes of sₜ and aₜ. The reward function is defined as follows if the harvest occurs at time t:

$${r}_{t} ( {s}_{t} , {a}_{t} ) = {w}_{1} Y - {w}_{2} {N}_{t} - {w}_{3} {W}_{t} - {w}_{4} {N}_{l , t}$$

Otherwise:

$${r}_{t} ( {s}_{t} , {a}_{t} ) = - {w}_{2} {N}_{t} - {w}_{3} {W}_{t} - {w}_{4} {N}_{l , t}$$

Where w₁, w₂, w₃, and w₄ represent four custom weight factors, Y denotes the yield at harvest, and N_{l,t} indicates the amount of nitrate leaching on a given day, respectively.

Both Y and N_{l,t} are derived from the state variable sₜ. The reward function design, characterized by the weights w₁, w₂, w₃, and w₄, plays a role in guiding the agent's strategy. The agent's objective is to determine a policy π(sₜ,θₜ), which selects action aₜ to maximize the total future return. This return is defined as:

$${R}_{t} = {\sum }_{τ = t}^{T} {γ}^{τ - t} {r}_{τ}$$

The return represents the accumulated rewards from the current action aₜ to future rewards, each discounted by the factor γ to account for the principle that a gain experienced in the future typically has less value than a gain experienced in the present.

### B. State Masking

The embodiments herein utilize a masking strategy to mimic the states that can be accessed in reality, preparing the trained RL agent for deployment and stable performance. For the training stage, the masking process in FIG. 3 is used. For a batch of states, their original and fully observed conditions are referred to as s_{F}. For each state, a subset of its features are selected and masked out using masks denoted by m. More specifically, m consists of a series of zeros and ones, where the ones correspond to the state features retained, and the zeros correspond to the features selected for masking following a uniform distribution. The masked ratio α is defined as the ratio of the number of masked states to the total number of states. Then, the masked and partially observed state is defined as s_{P}=s_{F}⊙m, where ⊙ denotes the element-wise masking operation between the fully observed state s_{F} and the mask m. The operation strategy is as follows: when the element in the mask m is 0, the corresponding element in s_{P} is replaced with “#”.

In the inference stage of real-world applications, fully observed states SF are no longer available. Instead, all state features are partially observed due to real-world constraints such as the availability of sensors, weather conditions, or other limitations. Consequently, during deployment, all states will naturally be partially observed. Therefore, the RL agent can utilize these partially observed states s_{P} directly for decision-making.

In the fields of computer vision and NLP, masking strategies typically require high masking ratios due to the redundancy and structured nature of images and texts. In contrast, the approach herein adopts a lower masking ratio, reflecting the less redundant and less structured nature of the states analyzed. This allows a modest masking ratio, such as 30%, to effectively create a challenging pre-task, prompting the RL agent to infer missing features and learn latent dependencies. On the other hand, using a higher masking ratio in this context could disrupt training stability. To mitigate potential center bias and enhance adaptability, a is uniformly sampled within a specified range. This approach allows the trained RL agent to perform effectively across diverse real-world applications. By reducing its reliance on specific state features, the agent can make informed decisions under varying conditions of state availability, thereby fostering more robust and noise-resistant decision-making.

### C. Policy Training

The Deep Q-Network (DQN) framework is used to train the agent. The DQN framework is a reinforcement learning approach that uses deep learning to approximate the Q-values of state-action pairs, enabling an agent to learn improved policies for decision-making in complex environments. In traditional Q-learning, a table is used to store Q-values that represent the expected future benefit for taking certain actions in specific states. However, in environments with large or continuous state spaces, maintaining such a table becomes infeasible. DQN addresses this by using a deep neural network to approximate the Q-function, which generalizes across a vast space of possible states and actions. The network takes the current state as input and outputs Q-values for each possible action, allowing the agent to choose actions that improve the expected benefit (e.g., the highest of the Q-values, which is expected to provide the highest reward over time in terms of crop performance).

The objective is to learn a policy that maximizes the future discounted return Rₜ. Within the DQN framework, an LM is used to predict the action-value function, i.e., the Q-function. More specifically, the Q-function is defined as:

$${Q}^{π} ( s , a ) = 𝔼 [ {R}_{t} \vert {s}_{t} = s , {a}_{t} = a , π ]$$

This Q-function is used to estimate the expected future return from the current state s and action a, when policy π is applied.

The LM serves as a bi-task RL agent. Specifically, the LM not only estimates the Q-values but is also designed to recover the masked or missing states. Due to its combined training (state recovery and Q-value estimation), the LM can predict the Q-values from partial state information.

On one hand, an optimization goal is to refine the parameters of the Q-network to achieve an improved Q function, Q*(s,a), which represents the highest possible return given the current state s and action a. For decision-making, a greedy policy defined as

$${a}_{t}^{*} = {max}_{a ∈ 𝒜} {Q}^{*} ( {s}_{t} , a ) .$$

observed due to the designed masking strategy. Therefore, the Q function accepts the input state s_{P}; i.e.:

$${Q}^{π} ( {s}_{P} , a ) = 𝔼 [ {R}_{t} \vert {s}_{t} = s , {a}_{t} = a , π ]$$

The language model also plays the role of a transition function, T(s_{P},a)=ŝ_{F}, to recover the partially observed states to the approximated fully observed ones.

In summary, the overall framework that effectively explores the policy space and recovers masked states using the following loss function:

$${L}_{i} ( {θ}_{i} ) {=}^{Δ} {L}_{i , 1} ( {θ}_{i} ) + λ {L}_{i , 2} ( {s}_{F} , {\hat{s}}_{F} )$$

Where

$${L}_{i , 1} ( {θ}_{i} ) {=}^{Δ} {E}_{{s}_{F} , a , r , {s}^{′}} [ r + γ {max}_{{a}^{′} ∈ 𝒜} Q ( {s}^{′} , {a}^{′} ; {θ}_{i}^{-} ) - Q ( {s}_{F} , a ; {θ}_{i} ) ] And$$

$${L}_{i , 2} ( {s}_{F} , {\hat{s}}_{F} ) = M S E ( {s}_{F} , {\hat{s}}_{F} )$$

Here s_{P}, s_{F}, ŝ_{F}, a, r, and s′ denote the partially observed state, fully observed state, recovered fully observed state, action, reward, and next state, respectively, while λ is designed to balance the two optimization objectives. Additionally, γ represents the discount factor,

$${θ}_{i}^{-}$$

denotes the parameters of a previously defined target network, and MSE stands for mean squared error. The values of the tuple s_{F}, a, r, s′ for the loss function can be randomly sampled from the replay buffer, a collection of prior state-action-reward-next state tuples accumulated during training.

The first term in the loss function, L_{i,1}, can be thought of as the expected cumulative reward. The second term, L_{i,2}, can be thought of the accuracy of the missing state predictions. The full loss function with both terms is designed to have lower values as the reward increases and as the mean-squared error (MSE) between the partially observed state and the fully observed state decreases.

As shown in FIG. 3, the training involves a number of iterations of masking fully observed states to form partially observed states, and then using these partially observed states to predict an action. The predicted action, when carried out, causes the crop state (as simulated using DSSAT) to update in response, leading to a further set of fully observed states. The weights of the LM-based RL agent are adjusted accordingly using the loss function until they converge. Given enough training iterations (e.g., hundreds, thousands, or more), the LM-based RL agent will learn how to predict the missing state information in the partial observed states and to (perhaps in parallel) predict an action that is likely (perhaps most likely) to lead to a high reward.

### V. EXPERIMENTAL RESULTS

This section introduces the initial experimental setup for the subsequent experiments, including the datasets and settings. Following this, the details of the training and evaluation processes are provided. Then, the evaluation results are presented, where the performance of the proposed method is compared against SoTA approaches in both fully observed and partially observed settings. Additionally, ablation studies are used to further analyze the method's effectiveness.

### A. Setup

The studies examining training policies for nitrogen and irrigation management in maize crops encompassed two separate case studies, both employing real-world data. The initial case study took place in a simulated setting modeled after Florida, USA, in 1982, whereas the second was based on simulations of Zaragoza, Spain, in 1995.

For a more comprehensive evaluation of the proposed framework, DQN was utilized to train the RL agent using a masking strategy for both partially and fully observed states. The performance of all developed policies was benchmarked against existing SoTA methods. Specifically, the baseline for the Florida study was drawn from a maize production guide for Florida farmers, while the baseline for the Zaragoza study was based on survey data regarding maize farming practices in Zaragoza.

### B. Evaluation Metrics and Implementation

The framework was implemented to train the RL agent under conditions of both partial and full observation. In these settings, the method involved testing with four different reward functions (although more or fewer could be used), each designed to showcase the adaptability of the framework to various agricultural trade-offs. These include balancing crop yield, nitrogen fertilizer usage, irrigation water consumption, and environmental impacts. This diversity in reward functions enables the framework to be evaluated across a spectrum of scenarios and objectives, demonstrating its versatility in addressing different agricultural management challenges.

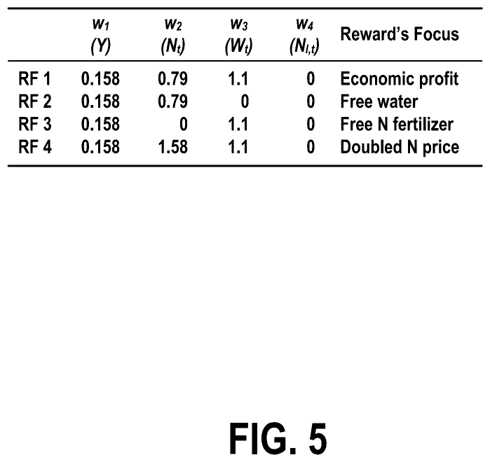

Specifically, four unique reward functions for Rₜ, employing different values of weights w₁, w₂, w₃, and w₄, were employed to train the RL agent. A single trained policy was selected for evaluation for each reward function, with weights for each listed in FIG. 5. RF1 measures the gain ($/ha) accrued by farmers (where “ha” abbreviates “hectare”), calculated based on the prevailing market prices of maize and the costs associated with nitrogen fertilizer and irrigation water. RF2-RF4 explore variations of economic profit under different hypothetical scenarios: RF2 assumes irrigation water is free; RF3 assumes nitrogen fertilizer is free; and RF4 models a scenario where the price of nitrogen fertilizer is doubled.

The RL agent in the study employs a combination of DistilBERT and a three-layer fully connected neural network for feature adaptation. The process begins with DistilBERT encoding the state inputs into 768-dimensional embeddings. Notably, the parameters of DistilBERT are trained end-to-end in this model. After this initial encoding, the embeddings are passed through fully connected layers, one with 512 units and the other with 256 units. The final layer in this sequence is responsible for mapping these processed embeddings to the action space, completing the flow from the input state to the actionable output in the RL framework. The discrete action space is defined as follows:

$$𝒜 = \{ 40 k \frac{kg}{ha} nitrogen fertlizer and 6 k \frac{L}{{m}^{2}} irrigation water \}$$

Where k=0, 1, 2, 3, 4, for each term, resulting in 25 different possible actions. Also, the term

$$\frac{L}{{m}^{2}}$$

refers to liters per meters squared, and should not be confused with the loss function. This action space design incorporates standard quantities of nitrogen fertilizer and irrigation water that are typically applied by farmers in a single day. It also allows for a wide range of options, aiding the discovery of effective policies. The discount factor is set at 0.99. To facilitate the neural network's updates, Pytorch is employed alongside the Adam optimizer, characterized by an initial learning rate of 1e-5 and a batch size of 512. This setup is strategically chosen to facilitate the learning process while ensuring efficient computation.

Applying DistilBERT's tokenizer to numerical values causes significant training instability due to multiple token splits, resulting in large variances for small numerical differences. For instance, 360 tokenizes into [9475], while 361 splits into [4029, 2487], leading to disproportionate representations and instability. Tokenizing decimals worsens this issue, as 0.1 translates into [1014, 1012, 1015], causing unnecessary token proliferation and inefficiency. To address this, a preprocessing technique is used that normalizes numerical values to the range [0, 300] and uses only the integer part for tokenization. This ensures each number corresponds to a single token, simplifying and stabilizing the process. By focusing on integers, the token set is reduced to 27 distinct tokens, including 25 feature-specific tokens and two special tokens ([CLS] and [September]). This approach improves training stability and computational efficiency, desirable for optimizing crop management using RL and language models.

The masking ratio varies from 0% to 100%. Generally, larger masking ratios require longer training but demonstrate better generalization during deployment. The parameter λ was set to 0.02 to balance these two goals (but could be set to other values).

C. Policy Training with Full Observation and Random Masking

DQN was implemented for training with all states available. However, some of the states were intentionally masked to enable the RL agent to better mimic real-world observations. Different reward functions were tested to demonstrate the adaptability of the framework to various trade-offs among crop yield, nitrogen fertilizer use, irrigation water use, and environmental impact.

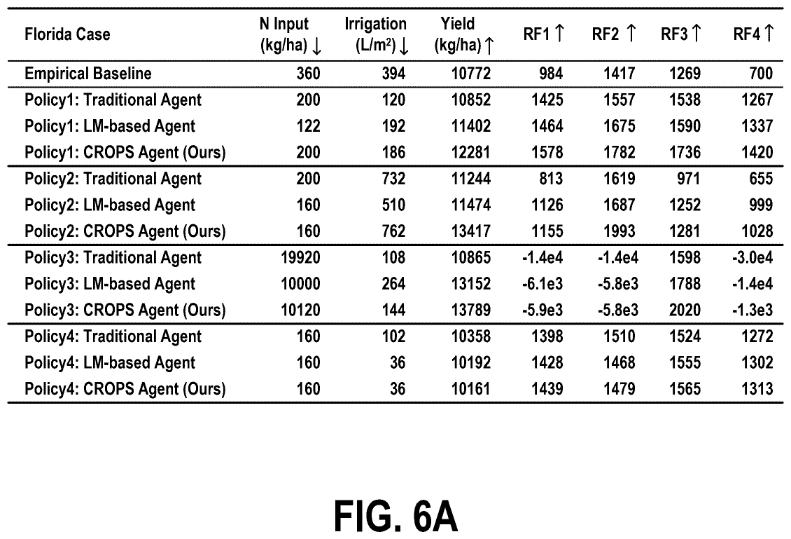

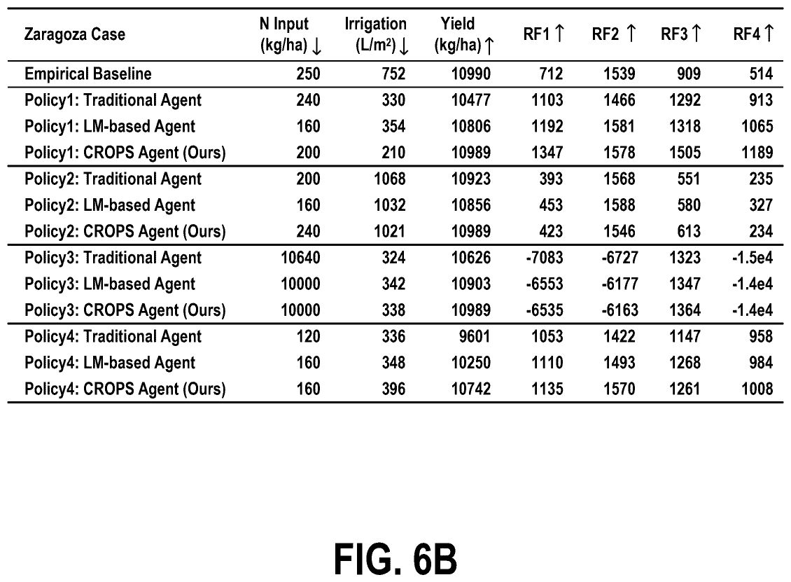

The evaluation results of the trained policies are presented in FIGS. 6A and 6B for the Florida and Zaragoza case studies, respectively. While the LM-based agent with random masking is not primarily designed to pursue SoTA results but rather to explore a more robust and deployable RL agent, it still outperforms previous SoTA methods and empirical baselines across most evaluation metrics (i.e., different reward functions) and various geographic locations, as a by-product. These consistent improvements across various reward functions that prioritize different optimization objectives underscore the agent's adaptability in optimizing for diverse agricultural goals.

Notably, unlike previous efforts that transform states into descriptive language to enrich their semantic meaning, direct tokenization of state variables can achieve similar results when using language models as agents. This indicates that language models can understand the underlying relationships between tokens and rewards without requiring redundant descriptions. Consequently, this approach is not only more straightforward to implement but also simplifies the preprocessing of states, thereby reducing usage of computational resources.

### D. Policy Evaluation Under Partial Observation

The previous section included masked training with all states available from DSSAT. However, many of these states are not readily measurable or accessible to farmers due to limitations in available instruments. Although there have been attempts to leverage imitation learning to guide partially observed agents in accomplishing crop management tasks, these approaches rely on predefined partially observed states.

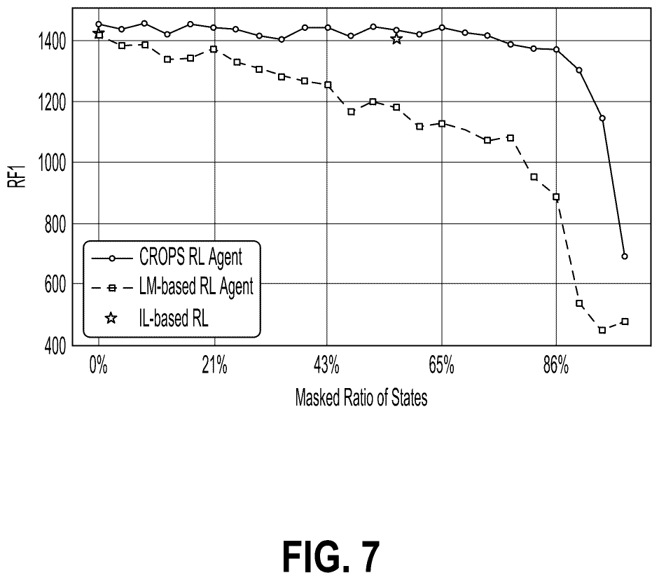

To address this issue, a pre-trained LM-based RL agent with random masking was used. After the training, the trained RL agent was evaluated under partial observation settings. In this stage, a specific percentage of the states are randomly masked, defined as α. For each α, its value was kept unchanged but masked states were randomly selected. The average of the results of such experiments over 100 trials appears FIG. 7. Notably, α varies from 0% to 100% during inference and evaluation. As the available states gradually decrease, there is a corresponding decrease in RF1. However, the decreasing curve is significantly more moderate than the one without masking, i.e., LM-based RL Agent.

More importantly, the performance of the CROPS RL agent was compared with IL-based RL agent shown in stars in FIG. 7. CROPS not only surpassed the performance of the IL-based agent but also demonstrated significant advantages in real-world applicability. The mask-based RL agent's adaptability to various state availabilities makes it highly deployable across diverse scenarios. These observations strongly support the state-agnostic nature of the method and its ease of deployment, highlighting its potential for broad and effective application.

### E. Ablation

Ablation in machine learning is an experimental technique used to analyze the contributions of different parts of a model or algorithm by systematically removing or altering them to observe changes in performance. A goal of an ablation study is to understand which components or features are most relevant to the model's effectiveness.

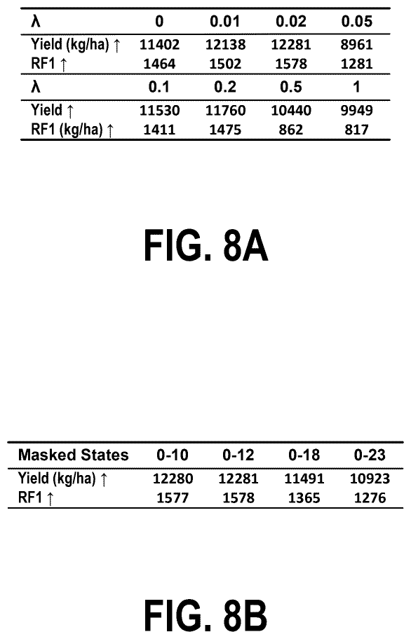

An ablation study was conducted on the hyperparameter λ, which is designed to balance the optimization of state recovery and crop management tasks. The results are shown in FIG. 8A. While the optimal λ is expected to be at or about 0.02, this value may vary slightly based on different locations. However, the optimal range should remain on the scale of 10⁻².

While masking states enhances the generalization capacity and robustness of the RL agent, excessive masking can result in information loss and training challenges. To determine a preferable masking range, experiments were conducted with results presented in FIG. 8B. The findings indicate that the optimal masking range is between 0 and 12 states. Consequently, the optimal α for each sampling falls within the range of 0 to 0.48. When α=0, all states are fully available. When α=0.48, 12 out of 25 states are masked out.

### VI. DEPLOYMENT

The policies trained in the DSSAT-simulated environment may not perform optimally in real-world conditions due to uncertainties in weather and discrepancies between the simulated crop models and actual cropping systems. This issue, referred to as the sim-to-real gap, underscores the difficulties in transferring RL policies from simulation to real-world scenarios.

To enhance the robustness of our trained policies against the challenges posed by the sim-to-real gap, previous methods incorporate domain and dynamics randomization techniques. This approach involves introducing variations in model parameters and randomizing conditions during policy training to mimic the potential variances and noises encountered in real-world scenarios. These perturbations encourage the policies to become resilient to noises during deployment. While a focus of the embodiments here is to establish the mask-based RL framework for crop management, enabling the robustness of these policies in real-world scenarios is desirable.

When deploying pre-trained policies in practice, farmers depend on observable states derived from weather forecasts and soil moisture measurements. However, these data sources are often prone to inaccuracies due to forecast errors and sensor limitations. To simulate this real-world scenario, experiments were conducted by retrieving the true state of the environment from the simulator and introducing random measurement noise to one or more key observable state variables.

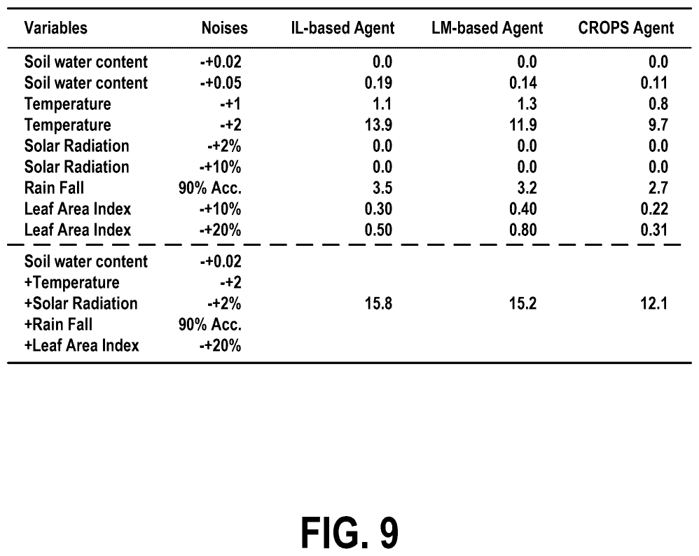

The values for measurement noise were determined based on real-world accuracy data from weather forecasts and commonly used soil moisture meters available on the market. For each level of measurement noise introduced, the policy was evaluated 400 times and the decrease rate of RF1 was reported in scenarios where no noise was applied. As demonstrated in FIG. 9, CROPS exhibits a smaller decrease in performance and delivers more satisfactory and robust results compared to previous methods. These findings demonstrate that the masking pre-training method inherently provides noise resilience during deployment, benefiting from its strategic masking approach.

### VII. EXAMPLE IRRIGATION AND FERTILIZER DELIVERY SYSTEMS

Irrigation systems applicable to the disclosed framework include a variety of delivery methods that differ in efficiency, precision, and infrastructure requirements. Surface irrigation methods, such as furrow and flood irrigation, represent traditional approaches where water is distributed across the soil surface by gravity. But these systems often result in substantial water loss through runoff and evaporation. More advanced methods, such as sprinkler irrigation, distribute water under pressure through nozzles, allowing for more uniform application. Drip irrigation systems, in contrast, deliver water directly to the root zone of each plant through a network of tubes and emitters. This approach minimizes evaporation, reduces weed growth, and is widely recognized as one of the most water-efficient irrigation techniques. Subsurface irrigation, which applies water below the soil surface, further reduces evaporation and is particularly suitable for high-value crops.

Fertilizer delivery systems similarly encompass a spectrum of techniques that can be integrated into the disclosed crop management framework. Broadcast fertilization involves spreading granular fertilizer across a field, e.g., with mechanical spreaders. But this method can lead to uneven distribution and increased runoff losses. Band application places fertilizer in concentrated strips near the seed or root zone, improving nutrient availability to plants and reducing losses. More modern approaches include fertigation, where soluble fertilizers are delivered directly through irrigation systems such as drip or sprinkler networks. This enables precise synchronization of water and nutrient supply with crop growth stages. Foliar fertilization provides another option, whereby nutrient solutions are sprayed directly onto plant leaves for rapid uptake, typically as a supplement to soil-applied fertilizers.

The selection of irrigation and fertilizer delivery methods is influenced by factors such as crop type, soil characteristics, water availability, and other considerations. The disclosed LM-based reinforcement learning framework is independent of the delivery system itself but can improve decision-making across all such systems by determining when and how much water and fertilizer should be applied. By integrating with precision delivery mechanisms such as drip irrigation or fertigation, the embodiments herein can achieve further efficiency gains, such that resource inputs are matched to plant needs while reducing waste and negative environmental impact.

### VIII. EXAMPLE TECHNICAL IMPROVEMENTS

Embodiments of the present disclosure provide several technical benefits arising from the integration of language model-based reinforcement learning with a masking strategy for crop management. By formulating irrigation and fertilization as an MDP, the system enables precise resource allocation decisions while accounting for variable weather, soil, and crop conditions. The use of an LM-based agent capable of inferring missing state variables provides an advantage in terms of robustness, allowing the system to operate effectively in real-world scenarios where sensor data may be noisy, incomplete, or entirely unavailable. This feature reduces dependence on costly or redundant sensor infrastructure, thereby reducing deployment barriers.

A further technical benefit derives from the adaptability of the masking strategy. During training, random masking causes the agent to learn latent dependencies among state variables, enhancing its capacity to generalize across diverse environments. As a result, the trained policies exhibit strong performance not only in simulation but also in partially observed and noisy real-world conditions. Unlike prior methods that require rigidly pre-defined partially observed states or extensive domain adaptation, the disclosed system demonstrates state-agnostic deployment capabilities. This significantly improves applicability across geographic regions, crop types, and environmental conditions without the need for extensive re-training.

The disclosed methodology also improves computational efficiency in training and inference. The use of language models, particularly lightweight variants, permits high-dimensional feature encoding without introducing instability or prohibitive resource requirements. Preprocessing strategies further stabilize training by simplifying tokenization of numerical values, resulting in improved convergence and lower variance. This efficient architecture eliminates the necessity of multi-stage training and reduces overhead compared to conventional approaches, making the system more practical for large-scale agricultural deployment.

The framework also provides concrete environmental and resource conservation benefits that are direct consequences of its technical advances. By specifying irrigation and fertilizer inputs with greater precision, the system reduces unnecessary water consumption, lowers nitrate leaching, and mitigates greenhouse gas emissions from excess nitrogen use. The capacity to adapt policies under different scenarios (e.g., changes in fertilizer or water scarcity) allows for flexible improvements to both crop yield and ecological sustainability. Accordingly, embodiments herein provide not only improvements in the computational domain but also in the efficient use of natural resources, thereby contributing to long-term agricultural resilience and sustainability.

Other technical improvements may also flow from these embodiments, and other technical problems may be solved. Thus, this statement of technical improvements is not limiting and instead constitutes examples of advantages that can be realized from the embodiments.

### IX. EXAMPLE OPERATIONS

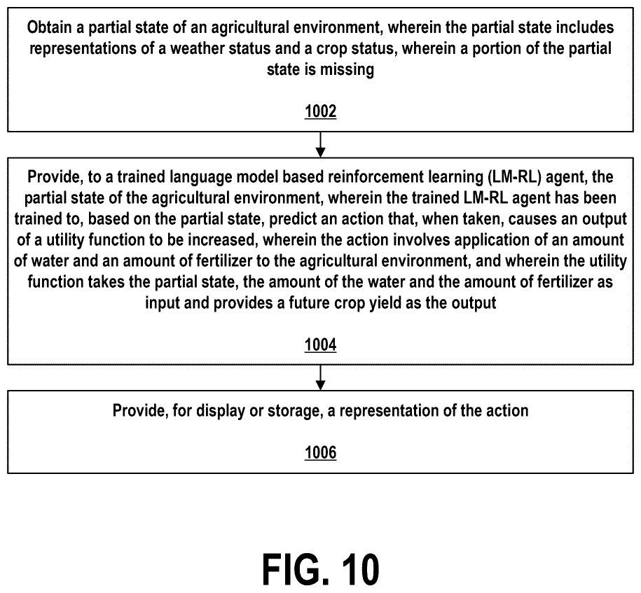

FIG. 10 is a flow chart illustrating an example embodiment. The process illustrated by FIG. 10 may be carried out by a computing device, such as computing device 100, and/or a cluster of computing devices, such as server cluster 200. However, the process can be carried out by other types of devices or device subsystems. For example, the process could be carried out by a portable computer, such as a laptop or a tablet device.

The embodiments of FIG. 10 may be simplified by the removal of any one or more of the features shown therein. Further, these embodiments may be combined with features, aspects, and/or implementations of any of the previous figures or otherwise described herein.

Block 1002 may involve obtaining a partial state of an agricultural environment, wherein the partial state includes representations of a weather status and a crop status, wherein a portion of the partial state is missing.

Block 1004 may involve providing, to a trained LM-RL agent, the partial state of the agricultural environment, wherein the trained LM-RL agent has been trained to, based on the partial state, predict an action that, when taken, causes an output of a utility function to be increased, wherein the action involves application of an amount of water and an amount of fertilizer to the agricultural environment, and wherein the utility function takes the partial state, the amount of the water and the amount of fertilizer as input and provides a future crop yield as the output.

Block 1006 may involve providing, for display or storage, a representation of the action.

Some embodiments may further involve causing an irrigation system to supply water to the agricultural environment in accordance with the action.

Some embodiments may further involve causing a fertilization system to supply fertilizer to the agricultural environment in accordance with the action.

In some embodiments, the crop status is based on plant growth and soil conditions in the agricultural environment.

In some embodiments, the action is to apply a first multiple of 40 kilograms per hectare of fertilizer and a second multiple of 6 liters per meter squared of water to the agricultural environment.

In some embodiments, the utility function was derived from a deep Q-network that was trained to simulate the utility function.

In some embodiments, the trained LM-RL agent has also been trained to derive a complete state by inferring observations for the portion of the partial state that is missing. These embodiments may further involve providing, for display or storage, a further representation of the complete state.

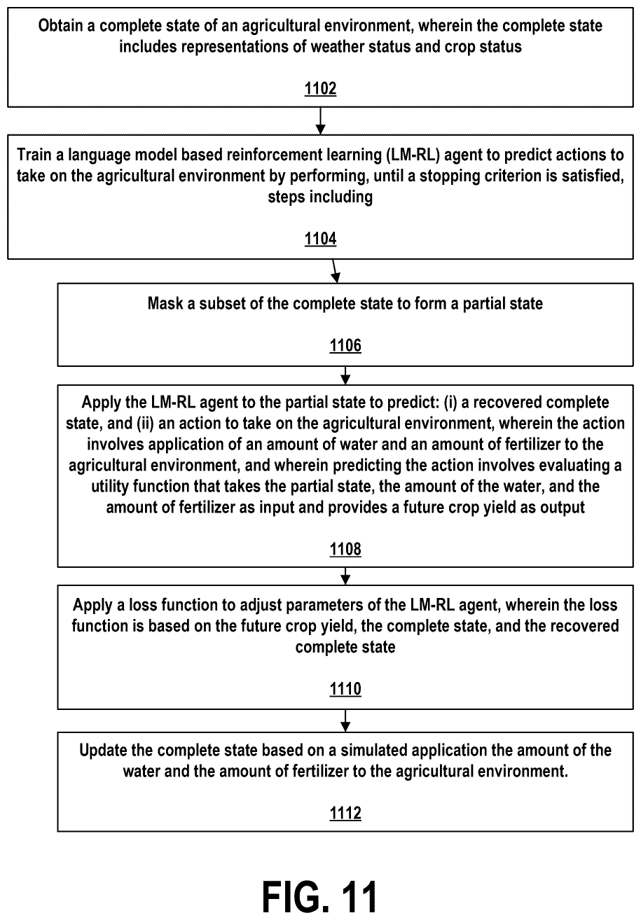

FIG. 11 is a flow chart illustrating an example embodiment. The process illustrated by FIG. 11 may be carried out by a computing device, such as computing device 100, and/or a cluster of computing devices, such as server cluster 200. However, the process can be carried out by other types of devices or device subsystems. For example, the process could be carried out by a portable computer, such as a laptop or a tablet device.

The embodiments of FIG. 11 may be simplified by the removal of any one or more of the features shown therein. Further, these embodiments may be combined with features, aspects, and/or implementations of any of the previous figures or otherwise described herein.

Block 1102 may involve obtaining a complete state of an agricultural environment, wherein the complete state includes representations of weather status and crop status.

Block 1104 may involve training an LM-RL agent to predict actions to take on the agricultural environment by performing, until a stopping criterion is satisfied, steps including the following.

Sub-block 1106 may involve masking a subset of the complete state to form a partial state.

Sub-block 1108 may involve applying the LM-RL agent to the partial state to predict: (i) a recovered complete state, and (ii) an action to take on the agricultural environment, wherein the action involves application of an amount of water and an amount of fertilizer to the agricultural environment, and wherein predicting the action involves evaluating a utility function that takes the partial state, the amount of the water, and the amount of fertilizer as input and provides a future crop yield as output.

Sub-block 1110 may involve applying a loss function to adjust parameters of the LM-RL agent, wherein the loss function is based on the future crop yield, the complete state, and the recovered complete state.

Sub-block 1112 may involve updating the complete state based on a simulated application the amount of the water and the amount of fertilizer to the agricultural environment.

In some embodiments, the stopping criterion is based on a number of iterations of the steps, the loss function being below a threshold value, or the loss function converging to within a range of values over multiple consecutive iterations of the steps.

In some embodiments, masking the subset of the complete state to form the partial state comprises masking between 20% and 40% of the complete state.

In some embodiments, the utility function is based on a deep Q-network that was trained to simulate the utility function.

Some embodiments may further involve: obtaining a further partial state of a further agricultural environment, wherein the further partial state includes representations of a further weather status and a further crop status, wherein a portion of the further partial state is missing; providing, to the LM-RL agent, the further partial state of the further agricultural environment; receiving, from the LM-RL agent, a predicted action; and providing, for display or storage, a representation of the predicted action.

Some embodiments may further involve causing an irrigation system to supply water to the further agricultural environment in accordance with the predicted action.

Some embodiments may further involve causing a fertilization system to supply fertilizer to the further agricultural environment in accordance with the predicted action.

### X. CLOSING

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A computer-implemented method comprising:
obtaining a partial state of an agricultural environment, wherein the partial state includes representations of a weather status and a crop status, wherein a portion of the partial state is missing;
providing, to a trained language model based reinforcement learning (LM-RL) agent, the partial state of the agricultural environment, wherein the trained LM-RL agent has been trained to, based on the partial state, predict an action that, when taken, causes an output of a utility function to be increased, wherein the action involves application of an amount of water and an amount of fertilizer to the agricultural environment, and wherein the utility function takes the partial state, the amount of the water and the amount of fertilizer as input and provides a future crop yield as the output; and
providing, for display or storage, a representation of the action.

2. The computer-implemented method of claim 1, further comprising:
causing an irrigation system to supply water to the agricultural environment in accordance with the action.

3. The computer-implemented method of claim 1, further comprising:
causing a fertilization system to supply fertilizer to the agricultural environment in accordance with the action.

4. The computer-implemented method of claim 1, wherein the crop status is based on plant growth and soil conditions in the agricultural environment.

5. The computer-implemented method of claim 1, wherein the action is to apply a first multiple of 40 kilograms per hectare of fertilizer and a second multiple of 6 liters per meter squared of water to the agricultural environment.

6. The computer-implemented method of claim 1, wherein the utility function was derived from a deep Q-network that was trained to simulate the utility function.

7. The computer-implemented method of claim 1, wherein the trained LM-RL agent has also been trained to derive a complete state by inferring observations for the portion of the partial state that is missing, the computer-implemented method further comprising:
providing, for display or storage, a further representation of the complete state.

8. A computer-implemented method comprising:
obtaining a complete state of an agricultural environment, wherein the complete state includes representations of weather status and crop status; and
training a language model based reinforcement learning (LM-RL) agent to predict actions to take on the agricultural environment by performing, until a stopping criterion is satisfied, steps including:
masking a subset of the complete state to form a partial state;
applying the LM-RL agent to the partial state to predict: (i) a recovered complete state, and (ii) an action to take on the agricultural environment, wherein the action involves application of an amount of water and an amount of fertilizer to the agricultural environment, and wherein predicting the action involves evaluating a utility function that takes the partial state, the amount of the water, and the amount of fertilizer as input and provides a future crop yield as output; and
applying a loss function to adjust parameters of the LM-RL agent, wherein the loss function is based on the future crop yield, the complete state, and the recovered complete state; and
updating the complete state based on a simulated application the amount of the water and the amount of fertilizer to the agricultural environment.

9. The computer-implemented method of claim 8, wherein the stopping criterion is based on a number of iterations of the steps, the loss function being below a threshold value, or the loss function converging to within a range of values over multiple consecutive iterations of the steps.

10. The computer-implemented method of claim 8, wherein masking the subset of the complete state to form the partial state comprises masking between 20% and 40% of the complete state.

11. The computer-implemented method of claim 8, wherein the utility function is based on a deep Q-network that was trained to simulate the utility function.

12. The computer-implemented method of claim 8, further comprising:
obtaining a further partial state of a further agricultural environment, wherein the further partial state includes representations of a further weather status and a further crop status, wherein a portion of the further partial state is missing;
providing, to the LM-RL agent, the further partial state of the further agricultural environment;
receiving, from the LM-RL agent, a predicted action; and
providing, for display or storage, a representation of the predicted action.

13. The computer-implemented method of claim 12, further comprising:
causing an irrigation system to supply water to the further agricultural environment in accordance with the predicted action.

14. The computer-implemented method of claim 12, further comprising:
causing a fertilization system to supply fertilizer to the further agricultural environment in accordance with the predicted action.

15. A non-transitory computer-readable medium, having stored thereon program instructions that, upon execution by a computing system, cause the computing system to perform operations comprising:
obtaining a partial state of an agricultural environment, wherein the partial state includes representations of a weather status and a crop status, wherein a portion of the partial state is missing;
providing, to a trained language model based reinforcement learning (LM-RL) agent, the partial state of the agricultural environment, wherein the trained LM-RL agent has been trained to, based on the partial state, predict an action that, when taken, causes an output of a utility function to be increased, wherein the action involves application of an amount of water and an amount of fertilizer to the agricultural environment, and wherein the utility function takes the partial state, the amount of the water and the amount of fertilizer as input and provides a future crop yield as the output; and
providing, for display or storage, a representation of the action.

16. The non-transitory computer-readable medium of claim 15, the operations further comprising:
causing an irrigation system to supply water to the agricultural environment in accordance with the action.

17. The non-transitory computer-readable medium of claim 15, the operations further comprising:
causing a fertilization system to supply fertilizer to the agricultural environment in accordance with the action.

18. The non-transitory computer-readable medium of claim 15, wherein the crop status is based on plant growth and soil conditions in the agricultural environment.

19. The non-transitory computer-readable medium of claim 15, wherein the action is to apply a first multiple of 40 kilograms per hectare of fertilizer and a second multiple of 6 liters per meter squared of water to the agricultural environment.

20. The non-transitory computer-readable medium of claim 15, wherein the trained LM-RL agent has also been trained to derive a complete state by inferring observations for the portion of the partial state that is missing, the operations further comprising:
providing, for display or storage, a further representation of the complete state.
